(19) United States
(12) Patent Application Publication
(10) Pub. No.: US 2020/0001376 A1
(43) Pub. Date: Jan. 2, 2020

(54) DRILLING TOOL

(71) Applicant: HPTec GmbH, Ravensburg (DE)

(72) Inventor: Stefan NETZER, Wolfegg (DE)

(73) Assignee: HPTec GmbH, Ravensburg (DE)

(21) Appl. No.: 16/564,105

(22) Filed: Sep. 9, 2019

Related U.S. Application Data
(63) Continuation of application No. PCT/EP2018/055586, filed on Mar. 7, 2018.

(30) Foreign Application Priority Data
Mar. 10, 2017 (DE) 102017105171.6

(51) Int. Cl. B23B 51/02

(52) U.S. Cl. CPC B23B 51/02; B23B 2251/046; B23B 2251/426; B23B 2251/18; B23B 2251/408

(57) ABSTRACT

Proposed is a drilling tool for drilling workpieces, having a tool tip and a basic body and a core, wherein the basic body has at least one main groove as at least one helical depression, for the purpose of realizing a conveying helix in each case. For the purpose of prolonging the service life, the core, in a first portion that starts at the tool tip and/or extends to the tool tip, has a constant cross-sectional area perpendicular to the axis of rotation and, in an adjoining second portion, counter to the direction of advance, has a cross-sectional area that increases, at least in portions.

### CROSS REFERENCE TO RELATED APPLICATIONS

This application is a continuation of International Application No. PCT/EP2018/055586 filed Mar. 7, 2018, which designated the United States, and claims the benefit under 35 USC § 119(a)-(d) of German Application No. 10 2017 105 171.6 filed Mar. 10, 2017, the entireties of which are incorporated herein by reference.

### FIELD OF THE INVENTION

The present invention relates to a drilling tool for drilling workpieces.

### BACKGROUND OF THE INVENTION

According to the prior art, drilling tools are usually reground after a certain period of time in operation; this also applies to comparatively small drills that are used, for example, in the manufacture of printed circuit boards (PCB). This operation is necessary because, during use, the tip of the drilling tool becomes ever more blunted as a result of the stress resulting from friction and impacts. Because of this, in the case of continuous use it also becomes ever more difficult for the drill, having a blunted tip, to be positioned in a centered manner, i.e. the precision of the tool is progressively lost. In particular, however, such small drills, for instance from the manufacturing of printed circuit boards, can normally only be reground once or twice and then, upon further blunting of the tool tip, they have a reduced performance.

The object of the present invention is to propose a drilling tool of which the service life can be increased.

The drilling tool according to the present invention for drilling workpieces comprises, firstly, a basic body and a tool tip that narrows, in particular, tapers conically, in the direction of advance along the axis of rotation. During chip-removing machining, the drilling tool is correspondingly rotatable, about this axis of rotation, in a direction of rotation. The basic body, in turn, comprises a main groove, in the form of at least one helical depression. Normally, there are two helical depressions. The depression relates to the rotational volume occupied by the rotating drilling tool. Chips, drilling dust and other material removed from the workpiece in the course of working can be transported away from the workpiece, within the helical depression, during the drilling operation, i.e. the helical depressions each correspond to a conveying helix.

During standstill, the drilling tool occupies a certain volume. In the region of the main body, during standstill the actual main groove, apart from the helical depressions (offset at an angle thereto), pervades the occupied volume. In rotation, the rotating main groove forms the corresponding rotational volume. Formed around this axis of rotation, in the center of the drilling tool, there is thus a core, which permanently, i.e. both during standstill and during rotation, pervades the occupied volume, minus the main groove.

Accordingly, the drilling tool according to the present invention is characterized in that the core, in a first portion that starts at the tool tip, or extends to the tool tip, has a constant cross-sectional area perpendicular to the axis of rotation and, in an adjoining second portion that is counter to the direction of advance, has a cross-sectional area that increases, at least in portions. As the tool tip of the drill becomes increasingly blunted in operation, it must be reground after a certain period of time.

As a result of the measure that the core is constant in its cross-sectional area in the front region of the drilling tool, i.e. in the region of the tool tip, the core located at the tool tip thus also does not change, in respect of its cross-sectional area, when the tool according to the present invention is reground there. For many applications, especially in the field of printed-circuit board manufacturing (PCB: printed-circuit board), it is actually often small drills having a core increase that are used.

In the case of these conventional drills known from the prior art, the cross-sectional area if the core varies contrary to the direction of advance, which geometrically results from the fact, inter alia, that the depth of the conveying helix decreases progressively contrary to the direction of advance. In a normal grinding operation, the tool is usually shortened (in the direction of the axis of rotation) by an amount of maximally approximately 0.05 mm, deviations from this being possible in individual cases. In the case of small drills (e.g. for PCB manufacture), little material is normally removed in the regrinding operation.

In the case of the drilling tool according to the present invention, however, the core remains constant in respect of its cross-sectional area in a first portion, this first portion being selected to be greater, in respect of its extent along the axis of rotation, than the length that is removed from the tool during grinding. In this way, effectively no geometric change occurs in the region of the tool tip, in comparison with the original, new drilling tool. The reground tool tip can again center the tool at the drilling point, while the cross-sectional area of the core has also not changed in comparison with the new tool. The size and geometry of the conveying helix, and of the cutting edges merging into the main groove, can thus be maintained.

Whereas, in the case of conventional drilling tools, regrinding could normally only be performed once or twice, in the case of the drilling tool according to the present invention the sizing operations can be effected more frequently. In the case of conventional drilling tools from the prior art, a significant change occurred already upon the first regrinding, in comparison with the original, new tool, since the core diameter, or the cross-sectional area or the core, also changed as a result of shortening of the tool. Since, upon regrinding, there is usually little shortening of the tool, it can generally also be expected that the cross-sectional area of the core also does not change significantly upon the first regrinding, even in the case of a conventional drilling tool according to the prior art. Upon repeated grinding, however, this change becomes ever greater, such that the performance of the drilling tool generally decreases at the latest after the second grinding in that, for example, the breakage rate increases, the surface quality of the drilling wall decreases, there is increased deflection of the tools in relation to the center, there is increased burr formation upon entry and exit, or the like.

In contrast to this, in the case of the drilling tool according to the present invention a drilling operation can basically be performed as often as it takes for the length of the drilling tool to be shortened such that the first portion, in which the cross-sectional area of the core is constant, has been used up. Overall, the precision can also be increased by the drilling tool according to the present invention, since the tool tip, or the region of the tool tip, does not necessarily change upon regrinding, but at most the tool itself is shortened somewhat in length.

In particular, in an embodiment of the present invention, in the first portion the contour lines of the core that lie in a cutting plane that includes the axis of rotation are parallel to the axis of rotation.

It is only in an adjoining second portion, which is thus at a greater distance from the tool tip than the first portion, that the cross-sectional area of the core increases, at least in portions.

In an embodiment of the present invention, the main groove, or the tool tip, may have at least one cutting edge, in particular, two cutting edges. The cutting edge formed by the main groove may continue in the region of the tool tip. The cutting edge of the main groove, or the secondary cutting edge, may in principle merge into a cutting edge in the region of the tool tip. The cutting edge in the region of the tool tip may thus in its course directly adjoin the secondary cutting edge, but a smooth transition need not be made between the two cutting edges. The realization of at least two secondary cutting edges enables the work to be distributed to the respective secondary cutting edges, and thus enables chips to be removed uniformly within the drilled hole.

In the second portion, depending on the embodiment variant of the present invention, the cross-sectional area of the core may increase monotonically, or even strictly monotonically, along the axis of rotation, contrary to the direction of advance, i.e. the cross-sectional area at least does not lessen as distance from the tool tip increases. However, it is also conceivable that, within the second portion, there are regions in which the cross-sectional area remains constant in portions, contrary to the direction of advance. Piece by piece, however, the depth of the conveying helix thus lessens progressively, such that, on the one hand, the stability of the drilling tool increases progressively toward the location at which the drilling tool is clamped, and the material removed from the workpiece is progressively forced out of the drilling tool.

In an exemplary embodiment of the present invention, however, the increase in the cross-sectional area may lessen progressively in a direction contrary to the direction of advance. This is advantageous, since the cross-sectional area of the core normally approximates to the thickness of the drilling tool, or possibly to the thickness of the shank in the region of which the tool is clamped. The depth of the conveying helix, or of the helical depression, thus tends toward zero as the distance from the tool tip increases. In other words, the inclination of the contour line of the core with respect to the axis of rotation decreases progressively as the distance from the tool tip increases, i.e. contrary to the direction of advance.

Since the contour lines of the core diverge progressively in a direction contrary to the direction of advance, along the axis of rotation, the cross-sectional area of the core will also normally become progressively greater in a section perpendicular to the axis of rotation.

In a development of the invention, the main groove has a spiral angle that decreases progressively contrary to the direction of advance in the course of the secondary cutting edge, specifically preferably in an angular range of from initially 43° to 38°. The spiral angle forms the angle between the secondary cutting edge and one perpendicular to the axis of rotation. The further a location on the drilling tool is away from the tool tip, the less will be the contribution there to the actual chip-removing machining, even in the case of deep bores. Normally, material transport of the chips, or drilling dust, is performed here in the region of the conveying helix, but scarcely any new material is removed from the workpiece. The closer one is to the tool tip, the more rapidly must transport of material be effected, because the machined-off chips and the machined-off drilling dust tend to interfere with the machining when material is being removed there from the workpiece.

### BRIEF DESCRIPTION OF THE DRAWINGS

An exemplary embodiment of the present invention is represented in the drawings and is explained in greater detail in the following, with further details and advantages being specified. In detail, there are shown:

FIG. 1 shows a representation of a drill according to the present invention, in a side view;

FIG. 2 shows a top view of the tool tip of the drill from FIG. 1, along the axis of rotation; and

FIG. 3 shows a schematic representation of the side view of a drill according to the present invention.

### DETAILED DESCRIPTION OF THE INVENTION

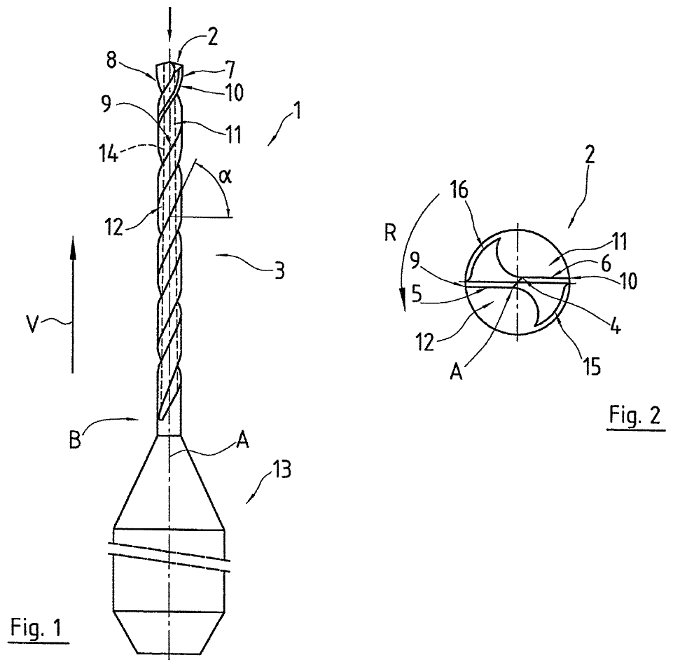

FIG. 1 shows a drill 1 having a tool tip 2 and a basic body 3. The drill 1 is rotated about an axis of rotation A for the purpose of drilling a workpiece. In a rotation about the axis of rotation A, the basic body 3 occupies a cylindrical volume.

The tool tip 2 is shown in a top view in FIG. 2. Going through the axis of rotation A is a chisel edge 4, which in turn merges into two main cutting edges 5, 6 of the tool tip 2. These main cutting edges 5, 6 extend outward, and then merge into the main groove 7, 8, or into the secondary cutting edges 9, 10. In the intermediate region of the main groove there are thus formed two helical depressions 11, 12, which serve as conveying helices and provide for transport of the machined-off drilling dust, or the machined-off chips, contrary to the direction of advance V. The conveying helices 11, 12 each end in the region of the point B. Up to this point, or up to this height, the depth of each also decreases. Additionally indicated, by way of example, is a spiral angle α, this angle decreasing, contrary to the direction of advance V, in the course from the tool tip 2 in the direction of the shank 13.

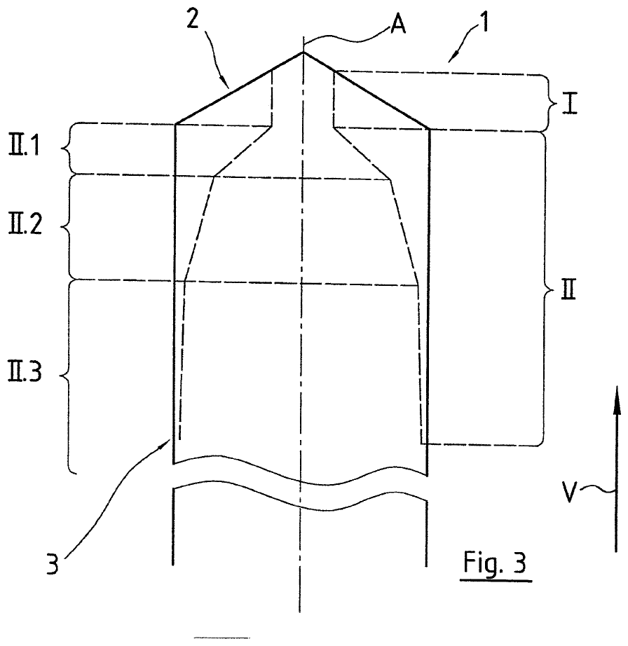

Also shown in FIG. 1, indicated by a broken line, is the core 14, its contour lines being represented in side view. In the case of the present exemplary embodiment, it is a core 14 that is substantially rotationally symmetrical about the axis of rotation A. Accordingly, in a sectional representation through the axis of rotation A, not only do its contour lines diverge in the direction contrary to the direction of advance V, but the cross-sectional area (measured perpendicularly to the axis of rotation) also increases correspondingly. As the cross-sectional area of the core 14 increases in the course contrary to the direction of advance V, the depth of the conveying helix 11, 12 also decreases with respect to the axis of rotation A. In the upper region close to the tool tip 2, however, in the first portion I, the cross-sectional area of the core 14 is constant (FIG. 3). In the subsequent second portion II, the cross-sectional area of the core 14 increases continuously in individual portions II.1, II.2, II.3. The cross-sectional area of the core 14 thus approximates to the cross-sectional area of the cylindrical rotational volume of the basic body 3. Thus, if it is necessary for the drilling tool 1 to be ground, the core 14 is retained in respect of its shape and cross-sectional area, and in effect does not differ from that of the original tool.

As additionally represented in FIGS. 1 and 2, behind the secondary cutting edges 9, 10 in the direction of rotation R there is a respective flank 15, 16, which is curved outwardly and is substantially parallel to the peripheral surface of the cylindrical rotational volume.

### LIST OF REFERENCES

1 drilling tool
2 tool tip
3 basic body
4 chisel cutting edge
5 main cutting edge
6 main cutting edge
7 main groove
8 main groove
9 secondary cutting edge
10 secondary cutting edge
11 conveying helix
12 conveying helix
13 shank
14 core
15 flank
16 flank
I first portion
II second portion
II.1 sub-portion
II.2 sub-portion
II.3 sub-portion
A axis of rotation
B end of the conveying helices
R direction of rotation
V direction of advance
α spiral angle

1. A drilling tool for drilling workpieces, which is rotatable about an axis of rotation in a direction of rotation during chip-removing machining, comprising:
a tool tip that narrows in the direction of advance along the axis of rotation, and
a basic body,
wherein the basic body has at least one main groove as at least one helical depression with respect to the rotational volume occupied by the rotating drilling tool, for the purpose of realizing a conveying helix,
wherein the volume occupied by the drilling tool during standstill, minus the at least one main groove, which is permanently pervaded both during standstill and during rotation defines a core, wherein the core, in a first portion that starts at the tool tip and/or extends to the tool tip, has a constant cross-sectional area perpendicular to the axis of rotation and, in an adjoining second portion, counter to the direction of advance, has a cross-sectional area that increases, at least in portions.

2. The drilling tool as claimed in claim 1, wherein the main groove and/or the tool tip has/have at least one cutting edge.

3. The drilling tool as claimed in claim 1, wherein, in the second portion, the cross-sectional area of the core increases monotonically along the axis of rotation, contrary to the direction of advance.

4. The drilling tool as claimed in claim 3, wherein the second portion has at least two successive sub-portions, which have an inclination in relation to the axis of rotation that decreases progressively along the axis of rotation, contrary to the direction of advance.

5. The drilling tool as claimed in claim 3, wherein, in the second portion, the increase in the cross-sectional area of the core lessens progressively contrary to the direction of advance.

6. The drilling tool as claimed in claim 3, wherein the second portion, contrary to the direction of advance, progressively approximates to the cross-sectional area of the rotational volume that is occupied by the rotating drilling tool.

7. The drilling tool as claimed in claim 1, wherein the at least one helical depression decreases progressively perpendicularly to the axis of rotation, contrary to the direction of advance.

8. The drilling tool as claimed in claim 1, wherein the at least one main groove in each case realizes a secondary cutting edge, which encloses a spiral angle, as an angle with respect to a perpendicular to the axis of rotation, which decreases in the course of the secondary cutting edge, contrary to the direction of advance, and which is preferably in the range of between 43° and 38°.

9. The drilling tool as claimed in claim 1, wherein the tool tip tapers conically.

10. The drilling tool as claimed in claim 1, wherein the at least one helical depression comprises two helical depressions.

11. The drilling tool as claimed in claim 1, wherein the at least one conveying helix comprises two conveying helices.

12. The drilling tool as claimed in claim 4, wherein the second portion has at least two successive sub-portions, which have an inclination in relation to the axis of rotation that decreases monotonically.

13. The drilling tool as claimed in claim 5, wherein, in the second portion, the increase in the cross-sectional area of the core lessens monotonically.

14. The drilling tool as claimed in claim 6, wherein the second portion, contrary to the direction of advance, monotonically approximates to the cross-sectional area of the rotational volume that is occupied by the rotating drilling tool.
